(19) United States
(12) Patent Application Publication
(10) Pub. No.: US 2006/0018462 A1
(43) Pub. Date: Jan. 26, 2006

(54) Make-before-break ADSL/VDSL splitter card

(76) Inventors: William J. Cregan, Ft. Worth, TX (US); Christian S. Duran, Ft. Worth, TX (US)

Correspondence Address: CORNING CABLE SYSTEMS LLC, P O BOX 489, HICKORY, NC, 28603, US

(21) Appl. No.: 10/874,940

(22) Filed: Jun. 23, 2004

(51) Int. Cl. H04M 1/76

(52) U.S. Cl. 379/417

(57) ABSTRACT

Methodologies and structure are provided for use in association with circuit cards employed in make-before-break systems to reduce or eliminate cross-talk between input and output circuit portions of splitter circuits that may be associated with ADSL/VDSL systems. Shielding structures are positioned as integral portions of printed circuit boards supporting splitter circuits in arrangements that reduce or eliminate signal coupling between parallel spaced conductive circuit card fingers that may be used to couple input and output signals to the high frequency circuits.

### FIELD OF THE INVENTION

The present invention generally concerns a methodology and apparatus for reducing cross-talk and increasing operational bandwidth in a communications device. Specialized shielding technology is utilized to permit higher operating frequency with printed circuit board devices used in conjunction with make-before-break systems.

### BACKGROUND OF THE INVENTION

Asymmetric Digital Subscriber Line (ADSL) systems have been in use for some time and, because of their relatively low operating frequency of no more than about 1.104 MHz, operate very compatibly with plain old telephone systems (POTS). More recently, however, Very High Speed Digital Subscriber Line (VDSL) systems and devices have been developed that operate at data rates and frequencies significantly higher than existing ADSL systems. Commonly in ADSL systems, a splitter circuit 140, as representatively illustrated in FIG. 3, may be provided in the form of the printed circuit card 150 illustrated in FIG. 4 that may be employed to connect a telephone line pair to Digital Subscriber Line equipment and, separately, to POTS equipment.

Generally such splitter cards have been employed in combination with a make-before-break connector 40, the operation of which is illustrated in FIGS. 5(a)-(d) that, previously, have operated quite adequately. In operation, a make-before-break connector 40 is configured, as one might imagine from its name, to provide a connection with a second circuit or device before an existing connection is broken or disconnected. As illustrated in FIGS. 5(a)-(d), a circuit card 50 with conductive fingers (not shown) on either surface of the circuit card, may be inserted into the make-before-break connector 40 to effectively couple the circuit contained on the circuit card with the electrical circuit to which the make-before-break connector 40 is associated.

As shown in FIG. 5(a), a circuit card 50 is about to be inserted into the make-before-break connector 40. Before card insertion, the contacts in plane 60 of the make-before-break connector 40 are slightly separated, but are separated by a distance less than the thickness of the circuit card 50. The contacts of the make-before-break connector 40 in plane 70, however, are in contact with one another so that a circuit is completed through the connector 40. As the circuit card 50 is inserted further into the connector 40, the conductive fingers (not shown) on the circuit card 50 come into contact with the contacts in plane 60 (FIG. 5(b)) and, upon further insertion (FIG. 5(c)) separate the contacts in plane 60 to accommodate the circuit card 50, while the contacts in plane 70 remain in contact with one another. At this stage, the circuit contained on the circuit card 50 is electrically coupled to the circuit with which the connector 40 is associated, but is shorted out by virtue of the contacts in plane 70 remaining in contact with one another.

As the circuit card is inserted further (FIG. 5(d)) into the make-before-break connector 40, the conductive fingers (not shown) on the circuit card 50 remain in contact with the contacts in plane 60, but now also come into contact with the contacts in plane 70 in such a manner as to force the contacts in plane 70 apart and, thereby, remove the short circuit and fully couple the circuit contained on the circuit card 50 with the circuit associated with the make-before-break connector 40.

One of the consequences of employing a make-before-break connection and corresponding circuit cards is the requirement that input and output connections associated with a particular circuit card be parallel to each other and physically placed on opposite sides of a single circuit card as illustrated in FIG. 4. For example, as shown in FIG. 4, previously known printed circuit card 150 includes terminals 152, 154 that may correspond to terminals to be connected to telephone exchange equipment, while terminals 156, 158 may correspond to terminals that are to be connected to a telephone line.

Referring to the drawings and to the previously known circuit card configuration, it will noted in particular that FIG. 4 depicts the formation of capacitors 170, 172, 174 as a consequence of the required placement of conductive fingers 152, 154, 156, 158, 160, and 162 separated by the insulation layer 180 that forms the principal body of the circuit card 150. With the increase in frequency occasioned by the introduction of VDSL technology, the effective capacitors 170, 172, 174 represent lower impedances to the signals coupled to the input and output terminals 152, 154, 156, 158, and therefore, provide an unintended signal path directly between the input and output terminals. This unintended signal path has been found to be at least one of the sources of cross-talk in the VDSL make-before-break systems.

As should be evident to those of ordinary skill in the art, if the printed circuit card 150 is not inserted into a make-before-break connector 40 associated with the telephone equipment, a connection from the telephone line to the telephone equipment should, nevertheless, be maintained. As a circuit card 150 is inserted into make-before-break connector 40, however, it is then essential that the input and output terminals associated with the previous connector be physically placed on opposite sides of the circuit card as previously discussed.

As previously noted, this type of configuration has not presented a problem with the previously employed lower frequency operation of ADSL equipment, however with the introduction of VDSL technology certain technical problems have been encountered. At least three problems have been identified with respect to the use of currently employed ADSL splitter cards when used in combination with make-before-break connectors systems and attempting to operate at the higher frequencies associated with VDSL systems. The first two of these problems involved attenuation characteristics associated with VDSL systems. First, existing ADSL splitter cards did not meet the attenuation characteristic of the VDSL specification in the lower frequencies, and, secondly, the splitter cards did not meet the attenuation requirements at the higher frequencies. Both of these problems could be resolved by redesigning the splitter circuits associated with the circuit cards, but the third problem identified, cross-talk, did not present an obvious solution.

While various ADSL/VDSL card splitters and make-before-break connector systems have been developed, no design has emerged that generally encompasses all of the desired characteristics as hereafter presented in accordance with the subject technology.

### SUMMARY OF THE INVENTION

In view of the recognized problems encountered in the prior art and addressed by the present invention, an improved methodology and apparatus for reducing or eliminating cross-talk in make-before-break connector systems has been developed. Shielding technology is incorporated into printed circuit boards supporting ADSL/VDSL splitter card components in a unique manner such that cross-talk resulting from required positioning of circuit board terminals associated with the operation of make-before-break connectors within the frequency environment of VDSL devices is reduced or eliminated.

Various features and aspects of the preset invention relate to a method for reducing cross-talk in a make-before-break system including providing a make-before-break connector, providing a printed circuit board card having parallel spaced signal input and output conductors, and providing signal inhibiting shielding between the input and output conductors in order to reduce or eliminate coupling of signals between the input and output conductors.

Yet another advantage of certain embodiments of the present invention relates to the provision of a make-before-break system including a make-before-break connector, a printed circuit board including an edge connector portion designed for insertion into the connector with the edge connector portion supporting parallel spaced input and output contacts adapted to convey electrical signals, and an electrical signal inhibiting shield positioned between the input and output contacts.

One particular aspect of certain embodiments of the present invention relates to a signal processor including a printed circuit board formed from a plurality of layers having a plurality of electrical components mounted on a first surface thereof, the printed circuit board also having a number of parallel aligned electrical conductors secured to edge portions of two sides thereof and having a conductive layer positioned between at least a first and second group of the parallel aligned electrical conductors.

In one exemplary embodiment of the present invention, a signal coupling inhibiting printed circuit board is provided that includes first and second insulating layers, a pair of electrical signal terminals secured to an edge portion of both of the first and second electrically insulating layers, each pair aligned in parallel relationship to the other, and an electrically conductive layer positioned at least between each pair of electrical signal terminals.

Additional aspects and advantages of the present invention are set forth in, or will be apparent to, those of ordinary skill in the art from the detailed description herein. Also, it should be further appreciated that modifications and variations to the specifically illustrated, referred and discussed features and steps hereof may be practiced in various embodiments and uses of the invention without departing from the spirit and scope of the invention. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present invention may include various combinations or configurations of presently disclosed features, steps, or elements, or their equivalents (including combinations of features, parts, or steps or configurations thereof not expressly shown in the accompanying drawings, or stated in the detailed description of the various exemplary embodiments). Additional embodiments of the present invention, not necessarily expressed in this summarized section, may include and incorporate various combinations of aspects of features, components, or steps referenced in the summarized objectives above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode of practice thereof currently known, directed to one of ordinary skill in the art, is set forth in the specification, which makes reference to the accompanying drawings, in which:

FIG. 1 depicts a printed circuit board in accordance with an exemplary embodiment of the present invention;

FIG. 2 depicts a second exemplary embodiment of the present invention;

FIG. 3 is a schematic diagram of a signal splitter circuit usable in combination with the representative printed circuit boards;

FIG. 4 illustrates a previously known printed circuit board configuration supporting a signal splitter circuit; and

FIGS. 5(a)-(d) represent various stages of insertion of a printed circuit board into a make-before-break connector.

Repeat use of reference characters throughout the present specification and appended drawings is intended to represent the same or analogous features or elements of the invention.

### DETAILED DESCRIPTION OF THE PREFERRED EMBODIMENTS

As discussed hereinabove, the present invention is particularly concerned with an improved system and method for reducing cross-talk in a make-before-break system and, in particular, in such a system as may be employed in conjunction with an ADSL/VDSL splitter circuit.

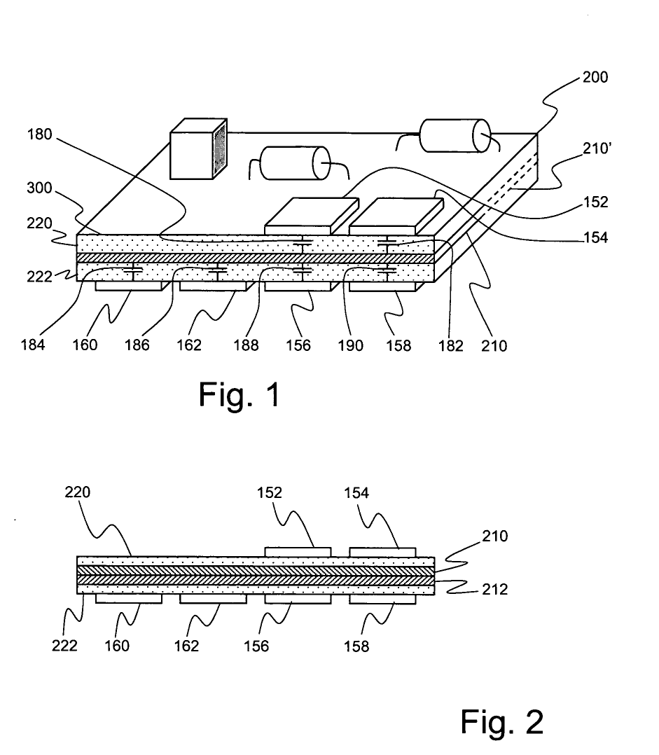

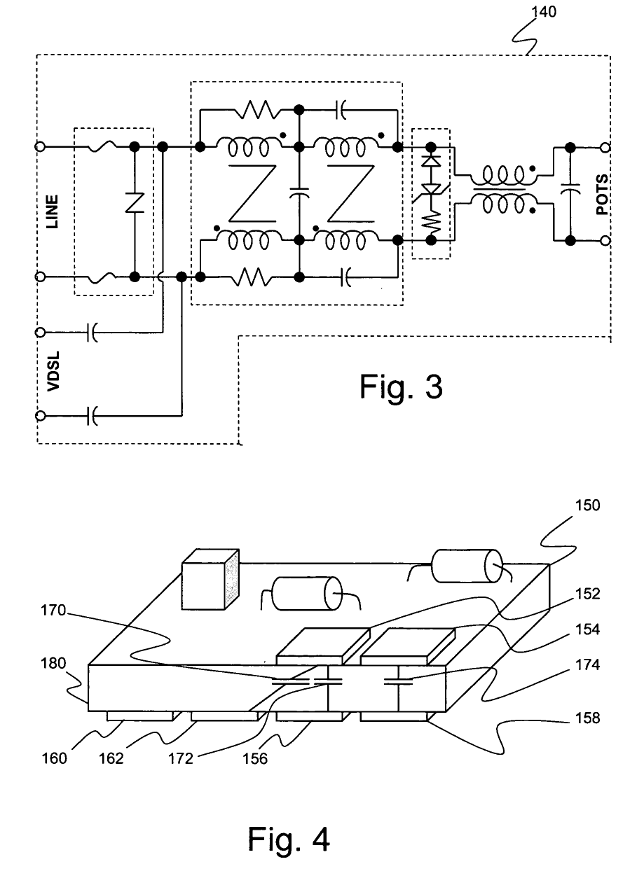

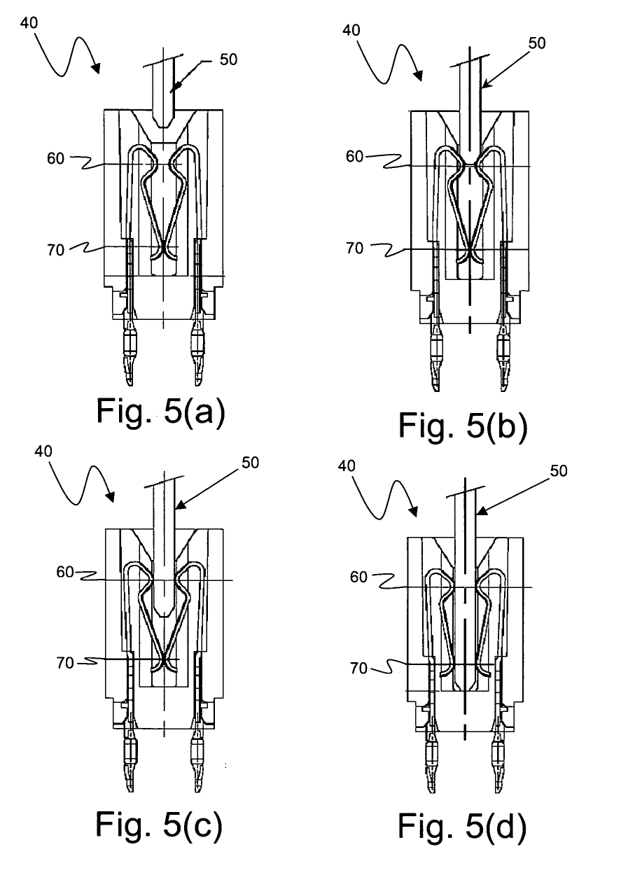

Reference will now be made in detail to exemplary embodiments of the subject apparatus and methodologies for reducing cross-talk in a make-before-break system. The present invention addresses the cross-talk problem previously discussed by providing a novel printed circuit board construction methodology wherein one or more shielding members are physically placed within the structure of the circuit card. More particularly, the present invention provides a multilayer printed circuit card 200, as depicted in FIG. 1, that includes at least one conductive layer 210 positioned between insulating layers 220, 222.

As shown in FIG. 1, conductive layer 210 may extend from a card edge portion 300 corresponding to the card edge supporting conductive fingers 152, 154, 156, 158, 160, 162 to a position in the direction of a central portion of the circuit card 200 that does not fully encompass the entire extent of the circuit card 200. Alternatively, the conductive layer 210 may be extended as illustrated at 210′ to cover the full extent of the circuit card 200. In addition, whether the conductive layer is designed as a full coverage layer or not, the conductive layer may optionally be electrically grounded in use to further enhance its shielding function.

Conductive layer 210, 210′ may consist of a layer of copper or, alternatively, could be composed of other conductive materials including aluminum, gold or silver. The specific choice of shielding materials as well as actual extent of layer coverage may be adjusted based on economic and other considerations. An important aspect of the material choice includes an adequate provisioning of sufficient shielding material to effect the desired high frequency shield balanced against cost of materials and ease of manufacturing considerations for the particular application.

With more specific reference to the cross-talk inhibiting conductive layer 210, 210′, it will be appreciated by those of ordinary skill in the art that the present invention provides a mechanism for reducing coupling, and, hence, cross-talk, whereby the presence of at least a partial layer of conductive material between the signal coupling terminals of a circuit card designed for use in a make-before-break system provides the desired effect.

Additional aspects of the present invention include the optional provision of at least one second conductive layer 212 (FIG. 2) together with the previously discussed conductive layer 210, 210′. Conductive layer 212, in a manner similar to conductive layer 210, 210′, may extend partially or fully across the extent of the printed circuit card 200, may be optionally grounded, and may be composed from material selected for the same group of alternative materials disclosed as applicable to materials suitable for conductive layer 210, 210′. It should be understood that it is not necessary that the materials selected for conductive layer 210, 210′ be the same material selected for conductive layer 212. As a non limiting example, conductive layer 210, 210′ may be composed of gold or silver while conductive layer 212, may be a copper layer. Alternatively, other material combinations may be selected. In like manner, one or both of the conductive layers 210, 210′ and 212 may be ground during circuit use to enhance the shielding effect produced by the respective conductive layers.

While the present invention has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for reducing cross-talk in a make-before-break system, comprising:
providing a make-before-break connector;
providing a printed circuit board card having parallel spaced signal input and output conductors; and
providing signal inhibiting shielding between the input and output conductors,
whereby direct coupling of signals between the input and output conductors is reduced.

2. The method of claim 2, wherein providing signal inhibiting shielding comprises providing at least one conductive layer between the signal input and output conductors.

3. The method of claim 3, wherein providing signal inhibiting shielding comprises providing at least two conductive layers between the signal input and output conductors.

4. The method of claim 3 wherein providing at least two conductive layers further comprises providing the at least two conductive layers adjacent and in electrical contact with one another.

5. The method of claim 2, further comprising grounding the at least one conductive layer.

6. The method of claim 1 wherein providing signal inhibiting shielding comprises providing the printed circuit board as a multilayer printed circuit board and wherein at least a portion of one layer of the multilayer printed circuit board is a conductive layer.

7. The method of claim 1 wherein providing signal inhibiting shielding comprises providing the printed circuit board as a multilayer printed circuit board and wherein at least a portion of at least two layers of the multilayer printed circuit board are conductive layers.

8. The method of claim 7 wherein providing signal inhibiting shielding further comprises providing the at least two conductive layers adjacent and in electrical contact with one another.

9. A make-before-break system, comprising:
a make-before-break connector;
a printed circuit board having an edge connector portion adapted for insertion into the make-before-break connector, the edge connector portion configured with parallel spaced input and output contacts adapted to convey electrical signals; and
an electrical signal inhibiting shield positioned between the input and output contacts.

10. A make-before-break system as in claim 9, wherein the printed circuit board comprises a plurality of individual layers and wherein the electrical signal inhibiting shield comprises at least a portion of one of the plurality of individual layers.

11. A make-before-break system as in claim 10, wherein the electrical signal inhibiting shield comprises a grounded conductive layer.

12. A make-before-break system as in claim 10, wherein the electrical signal inhibiting shield comprises at least a portion of two of the plurality of individual layers

13. A make-before-break system as in claim 12, wherein the at least two layers are adjacent and in electrical contact with one another.

14. A signal processor, comprising:
a printed circuit board comprising a plurality of layers, each layer having first and second surfaces;
a plurality of electrical components mounted on a first surface of one of the plurality of layers;
a first plurality of electrical conductors aligned in parallel with one another and secured to an edge portion of a first surface of a first layer of the plurality of layers;
a second plurality of electrical conductors aligned in parallel with one another and secured to an edge portion of a first surface of a second layer of the plurality of layers; and
a conductive layer positioned between the first and the second plurality of electrical conductors.

15. A signal processor as in claim 14, wherein a portion of the first and the second plurality of electrical conductors comprise input and output connection terminals for the signal processor and wherein the conductive layer is electrically grounded, whereby signal coupling between the input and output connection terminals is inhibited.

16. A signal processor as in claim 14, wherein the conductive layer comprises at least a portion of one of the plurality of layers.

17. A signal processor as in claim 14, wherein the conductive layer comprises one of the plurality of layers and wherein the layers of the plurality of layers are substantially coextensive with one another.

18. A signal processor as in claim 14, wherein the conductive layer comprises more than one of the plurality of layers and wherein the layers of the plurality of layers are substantially coextensive with one another.

19. A signal processor as in claim 18, wherein the plurality of layers comprising the conductive layer are adjacent and in electrical contact with one another.

20. A signal coupling inhibiting printed circuit board, comprising a first electrically insulating layer having first and second surfaces;
a second electrically insulating layer having first and second surfaces;
a pair of electrical signal input terminals secured to an edge portion of the first surface of the first electrically insulating layer;
a pair of electrical signal output terminals secured to an edge portion of the second surface of the second layer; and
a first electrically conductive layer positioned between the second surface of the first electrically insulating layer and the first surface of the second electrically insulating layer,
wherein the pair of electrical input signal terminals are positioned substantially parallel to the pair of electrical output signal terminals and the first electrically conductive layer inhibits electrical signal coupling between the electrical input signal terminals and electrical output signal terminals.

21. A signal coupling inhibiting printed circuit board as in claim 20, further comprising a second electrically conductive layer positioned between the second surface of the first electrically insulating layer and the first surface of the second electrically insulating layer.

22. A signal coupling inhibiting printed circuit board as in claim 21, wherein the first electrically conductive layer and the second electrically conductive layer are adjacent and in electrical contact with one another.

23. A signal coupling inhibiting printed circuit board as in claim 20, wherein the first electrically conductive layer is substantially coextensive with the first electrically insulating layer.
